(19) United States
(12) Patent Application Publication
(10) Pub. No.: US 2025/0369802 A1
(43) Pub. Date: Dec. 4, 2025

(54) FLUORESCENT PENETRANT INSPECTION APPARATUS

(71) Applicant: TOYOTA JIDOSHA KABUSHIKI KAISHA, Toyota-shi (JP)

(72) Inventor: Hiromasa YANAGASE, Ama-gun (JP)

(73) Assignee: TOYOTA JIDOSHA KABUSHIKI KAISHA, Toyota-shi (JP)

(21) Appl. No.: 19/210,569

(22) Filed: May 16, 2025

(30) Foreign Application Priority Data
May 29, 2024 (JP) 2024-087397

(51) Int. Cl. G01J 3/44; G01J 3/02; G01J 3/28; G01N 21/64; G01N 21/88

(52) U.S. Cl. CPC G01J 3/4406; G01J 3/0202; G01J 3/0267; G01J 3/2823; G01N 21/6456; G01N 21/8806; G01J 3/0264

(57) ABSTRACT

The fluorescent penetrant inspection apparatus comprises a wide area camera and a local area camera. The wide area camera captures an image of an object to be inspected. The wide area camera includes a first lens barrel. The local area camera includes a second lens barrel and a small ring light (an ultraviolet flaw detection lamp). The small ring light is disposed around the second lens barrel. The diameter of the small ring light is less than the diameter of the first lens barrel. And the second lens barrel has a barrel length longer than the first lens barrel.

### CROSS REFERENCE TO RELATED APPLICATION

This application claims priority to Japanese Patent Application No. 2024-087397, filed on May 29, 2024, which is incorporated herein by reference in its entirety including the specification, claims, drawings, and abstract.

### TECHNICAL FIELD

Disclosed herein is a fluorescent penetrant inspection apparatus.

### BACKGROUND

JP2012-83285A discloses an appearance inspection apparatus. The fluorescent agent permeates the surface of the test object. Then, the object to be inspected is irradiated with ultraviolet light. At this time, a fluorescence emission image of the test object is captured. A defect portion of the object to be inspected is identified based on the fluorescence emission image.

JPH07-113625A discloses an apparatus for inspecting an inner peripheral surface of a cylindrical body. The inspection apparatus includes an imaging camera. The imaging camera comprises an objective lens. A projection ring is arranged around the objective lens. An end of the optical fiber is disposed on the light projecting ring. The objective lens and the projection ring are inserted into the cylindrical body.

For example, when the object to be inspected is a cast product, a rib is formed for reinforcement. For example, a rib is erected along the advancing/retracting direction of the mold. As the size of the cast article becomes larger, the rib becomes higher. As a result, when the surface of the cast article is imaged, the rib may block light, and a shadow portion may be generated.

Therefore, in the present specification, a fluorescent penetrant inspection apparatus capable of suppressing imaging error caused by lengthening of a rib is disclosed.

### SUMMARY

Disclosed herein is a fluorescent penetrant inspection apparatus. The apparatus comprises a wide area camera and a local area camera. The wide area camera captures an image of an object to be inspected. The local area camera captures an image of a part of the object in a region captured by the wide area camera. The wide area camera includes a first lens barrel configured to support an objective lens. The local area camera includes a second lens barrel and an ultraviolet flaw detection lamp having a ring shape. The second lens barrel supports an objective lens. The ultraviolet flaw detection lamp is disposed around the second lens barrel. The diameter of the ultraviolet flaw detection lamp is less than the diameter of the first lens barrel. And the second lens barrel has a barrel length longer than the first lens barrel.

According to the above configuration, even if a shadow region occurs in the image captured by the wide area camera, the shadow region can be captured by using a local area camera that is elongated as compared with the wide area camera.

In the above configuration, the fluorescent penetrant inspection apparatus may include a robot arm and a processor. The robot arm moves the local area camera relative to the object to be inspected. The processor is configured to control the robot arm. The processor extracts a shadow region at the time of capturing the image by the wide area camera based on design data of the object to be inspected. And the processor includes the shadow region in a region to be captured by the local area camera.

According to the above configuration, the imaging region by the local area camera is set in advance based on the design drawing data of the object to be inspected. As compared with the case where the imaging region of the local area camera is set based on the captured image of the wide area camera, the time can be reduced.

In the above configuration, the fluorescent penetrant inspection apparatus may include a robot arm and a processor. The robot arm moves the local area camera relative to the object to be inspected. The processor is configured to control the robot arm. The processor extracts a shadow region from an image captured by the wide area camera. And the processor includes the shadow region in a region to be captured by the local area camera.

According to the above configuration, the imaging region by the local area camera is set based on the actual captured image by the wide area camera. As a result, error (loss) of the imaging region can be suppressed.

In the above configuration, the cross-sectional area of an opening to the shadow region may exceed the cross-sectional area of the ultraviolet flaw detection lamp. In such a case, the processor inserts an end of the second lens barrel into the shadow region via the robot arm.

According to the above configuration, it is possible to capture an image of the inside of the shadow region while avoiding damage to the local area camera.

In the above configuration, the local area camera may capture an image inside of the shadow region a plurality of times with the end of the second lens barrel inserted into the shadow region. In this case, the ultraviolet flaw detection lamp changes an intensity of ultraviolet light in each image capturing.

According to the above configuration, the reflected light from the bottom surface of the shadow region illuminates the side surface of the shadow region at the time of imaging with relatively high intensity of ultraviolet light. As a result, a side image of the shadow region can be obtained. Further, at the time of imaging with relatively low intensity of ultraviolet light, a bottom surface image of a shadow region can be obtained in a state in which halation is suppressed.

According to the fluorescent penetrant inspection apparatus disclosed in the present specification, it is possible to suppress imaging error due to lengthening of the rib.

### BRIEF DESCRIPTION OF DRAWINGS

Embodiments of the present disclosure will be described based on the following figures, wherein:

FIG. 1 illustrates a configuration of a fluorescent penetrant inspection apparatus according to the present embodiment;

FIG. 2 illustrates the structure of a robot arm, a wide area camera, a local area camera, a large ring light, and a small ring light;

FIG. 3 illustrates a hardware configuration of the computer apparatus;

FIG. 4 illustrates functional blocks of the computer apparatus;

FIG. 5 illustrates a flaw detection flow;

FIG. 6 illustrates an example of extracting a shadow region from design drawing data;

FIG. 7 illustrates an example of extracting a shadow region from an image captured by a wide area camera; and

FIG. 8 shows an example when a local area camera is inserted into a shadow region.

### DESCRIPTION OF EMBODIMENTS

### 1. Test Object

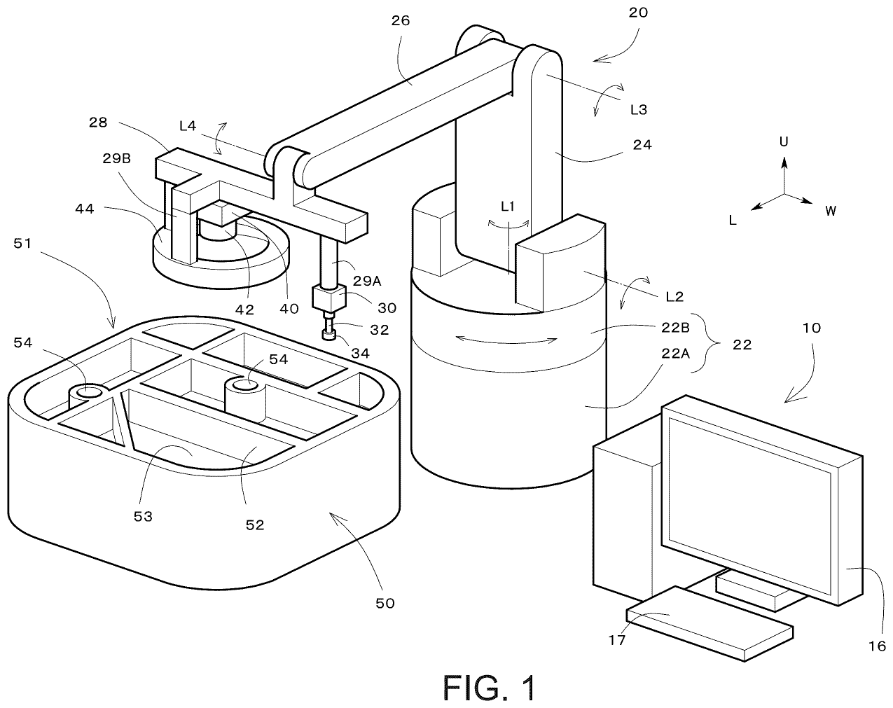

FIG. 1 illustrates a fluorescent penetrant inspection apparatus according to the present embodiment. In addition, FIG. 1 illustrates a test object 50.

In FIGS. 1, 2, and 8, an orthogonal coordinate system is shown. This orthogonal coordinate system is composed of a U-axis, an L-axis, and a W-axis. The U axis is a vertical axis. The L-axis and the W-axis extend on a horizontal plane. The L-axis and the W-axis are orthogonal to each other. The L-axis is parallel to the 0° line of the base 22 of the robot arm 20.

The test object 50 is, for example, a casting of aluminum. The test object 50 constitutes, for example, a part of a vehicle body. The to-be-inspected object 50 is a large-sized cast article in which a skeleton and a panel of a vehicle body is integrally molded.

Since the test object 50 is a part of the vehicle body skeleton, the test object 50 is required to have a predetermined strength. For example, the test object 50 is provided with a plurality of ribs 52. For example, when the object to be test object 50 is assembled to the vehicle body, the surface to be test surface 51 on which the rib 52 is formed becomes a part of the side surface of the vehicle body. That is, at the time of the flaw detection inspection, the test object 50 is laid down, and the test surface 51 becomes the upper surface.

In addition to the rib 52, a hole 54 is formed in the surface to be test surface 51. For example, the rib 52 is stood vertically from the bottom surface 53 of the surface to be test surface 51. Further, a hole 54 having the same depth as the height of the rib 52 is formed in the test surface 51.

As a method of fluorescent flaw detection, fluorescent magnetic powder flaw detection and fluorescent penetration flaw detection are known. Fluorescent magnetic powder flaw detection is not suitable for aluminum, which is a non-magnetic material. Therefore, a fluorescent penetration flaw detection is applied to a test object made of an aluminum casting.

In the fluorescence penetration flaw detection, a penetrant is applied to the test surface 51 to be inspected. A fluorescent substance is added to the permeate. After a predetermined time has elapsed from the application of the permeate, the permeate on the test surface 51 to be inspected is removed. Further, when the test surface 51 to be inspected is irradiated with ultraviolet rays, the penetrant infiltrated into (i.e., not removed from) the flaw or crack emits light.

As described later, when the wide area camera 40 images the test surface 51 to be inspected, ultraviolet light is irradiated from the large ring light 44. At this time, along with the lengthening of the rib 52 and the cylinder of the hole 54, a region in which ultraviolet light is blocked by the wall of the hole 54 and the rib 52 may occur on the test surface 51. The region where the ultraviolet light is blocked is called a shadow region. In the fluorescent penetrant inspection apparatus according to the present embodiment, the local area camera 30 captures an image of the shadow region.

### 2. Fluorescent Penetrant Inspection Apparatus

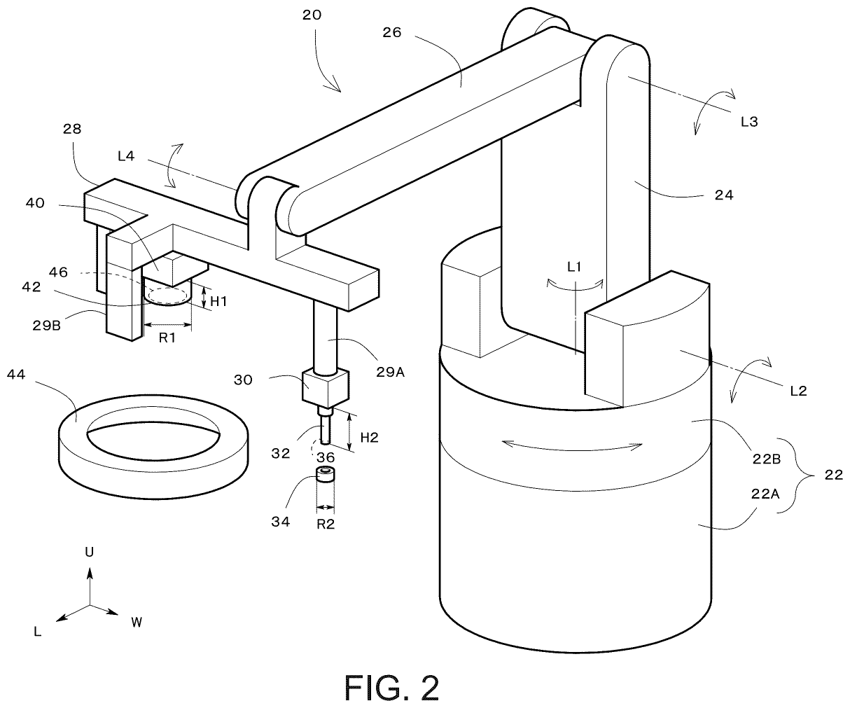

FIG. 2 illustrates a robot arm 20 and equipment supported by the arm. FIG. 2 illustrates a state in which the small ring light 34 and the large ring light 44 are removed from the robot arm 20. The robot arm 20 supports the wide area camera 40 and the local area camera 30. The robot arm 20 is, for example, a four-axis articulated robot. The robot arm 20 includes a base 22, a first arm 24, a second arm 26, and an attachment bar 28.

The base 22 includes a lower base portion 22A and an upper base portion 22B. The upper base portion 22B pivots about the axis L1 with respect to the lower base portion 22A. The axis L1 is parallel to the U-axis (vertical axis). For example, the upper base portion 22B is pivoted with respect to the lower base portion 22A by a servo motor (not shown).

One end of the first arm 24 is connected to the upper base portion 22B. One end of a second arm 26 is connected to the other end of the first arm 24. Further, an attachment bar 28 is connected to the other end of the second arm 26.

The first arm 24 rotates about the rotation axis L2 with respect to the upper base portion 22B. The second arm 26 rotates around the rotation axis L3 with respect to the first arm 24. Further, the attachment bar 28 rotates about the rotation axis L4 with respect to the second arm 26. Each of the rotation axes L2, L3, and L4 extends in the horizontal direction. The rotation axes L2, L3, and L4 are provided with servo motors (not shown).

The attachment bar 28 extends parallel to the rotation axis L4. For example, the attachment bar 28 is orthogonal to the second arm 26 along the rotation axis L4. A wide area camera 40 and a local area camera 30 are attached to the attachment bar 28 across the second arm 26. That is, the robot arm 20 moves the wide area camera 40 and the local area camera 30 with respect to the test object 50.

The wide area camera 40 captures an image of the test surface 51 over a wide area. For example, the wide area camera 40 captures an image of the test surface 51 in one shot. Hereinafter, the image captured by the wide area camera 40 may be referred to as a “wide area image” as appropriate.

For example, the wide area camera 40 is an interchangeable lens camera. The first lens barrel 42 is mounted on the lens mount of the wide area camera 40. The tip of the first lens barrel 42 supports the objective lens 46.

A large ring light 44 is attached to the attachment bar 28 so as to surround the first lens barrel 42. The large ring light 44 is a ring-type ultraviolet flaw detection lamp. The wide area camera 40 and the large ring light 44 are positioned so that the center of the large ring light 44 passes through the optical axis of the wide area camera 40.

For example, the large ring light 44 is a so-called UV ring light. In the large ring light 44, a plurality of UV-LEDs (not shown) are annularly arranged. The UV-LED emits ultraviolet light in a wavelength band (315 nm to 400 nm) of UV-A, for example.

The irradiation intensity of the large ring light 44 may be variable. For example, the irradiation intensity of the large ring light 44 varies between 0% and 100%. For example, the large ring light 44 can switch the intensity of two values of High (e.g., 100%) and Low (e.g., 20%).

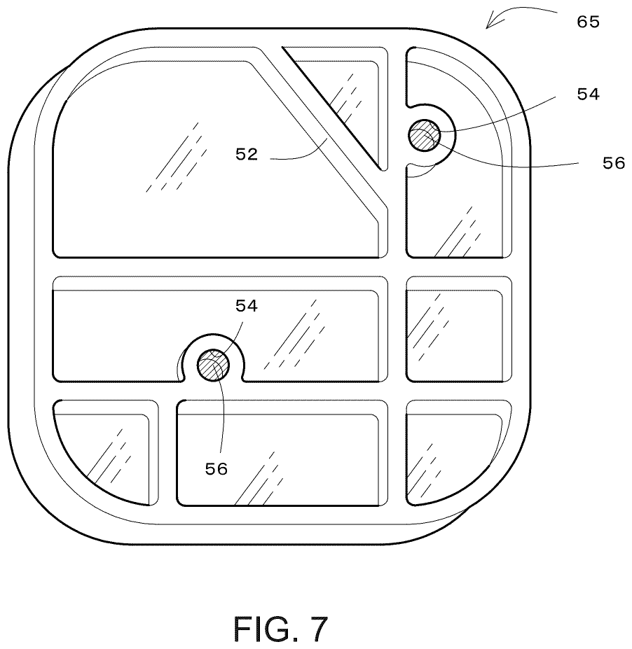

The local area camera 30 captures a part of an imaging region of the wide area camera 40. For example, the local area camera 30 captures an image of a shadow region 56 (see FIG. 7) in the wide-area image. Referring to FIG. 2, for example, local area camera 30 is an interchangeable lens camera. The second lens barrel 32 is mounted on the lens mount of the local area camera 30. An objective lens 36 is supported at the tip of the second lens barrel 32.

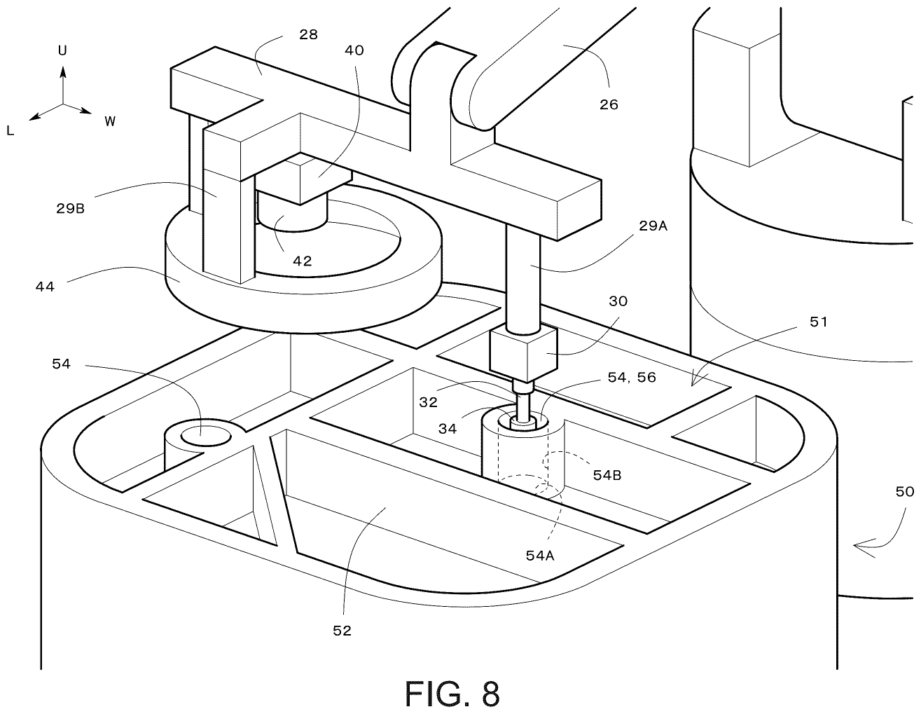

The second lens barrel 32 and the objective lens 36 are so-called hole inspection lens units. For example, in the flaw detection process, as shown in FIG. 8, the second lens barrel 32 is inserted into the hole 54. At this time, the bottom surface 54A and the inner peripheral surface 54B of the hole 54 are imaged. For example, the objective lens 36 (see FIG. 2) is a super-wide-angle lens called a fisheye lens.

For example, the diameter of the second lens barrel 32 is less than the diameter of the first lens barrel 42. For example, the diameter of the second lens barrel 32 is less than half the diameter of the first lens barrel 42. The cylindrical length H2 of the second lens barrel 32 is longer than the cylindrical length H1 of the first lens barrel 42.

A small ring light 34 is disposed around the second lens barrel 32. The small ring light 34 is a ring-type ultraviolet flaw detection lamp. For example, the small ring light 34 is a so-called UV ring light. The small ring light 34 has a plurality of UV-LEDs (not shown) arranged in an annular shape. The UV-LED emits ultraviolet light in a wavelength band (315 nm to 400 nm) of UV-A, for example.

The irradiation intensity of the small ring light 34 may be variable. For example, the irradiation intensity of the small ring light 34 varies between 0% and 100%. For example, the intensity of the small ring light 34 can be switched between two values of High (e.g., 100%) and Low (e.g., 20%).

The small ring light 34 is a ring-type lighting component. The local area camera 30 and the small ring light 34 are positioned such that the center of the small ring light 34 passes through the optical axis of the local area camera 30.

For example, the diameter of the inner peripheral surface of the small ring light 34 is equal to the diameter of the outer peripheral surface of the second lens barrel 32. For example, the small ring light 34 is put on the second lens barrel 32.

The diameter R2 of the small ring light 34 is smaller than the diameter R1 of the first lens barrel 42. With such a configuration, the second lens barrel 32 and the small ring light 34 can enter a portion narrower than the first lens barrel 42.

In addition, as described above, the cylindrical length H2 of the second lens barrel 32 is longer than the cylindrical length H1 of the first lens barrel 42. That is, the second lens barrel 32 protrudes downward relative to the first lens barrel 42. Therefore, even when the second lens barrel 32 is inserted into the hole 54 as shown in FIG. 8, the contact of the first lens barrel 42 with the test object 50 is suppressed.

The attachment bar 28 (see FIG. 2) may be provided with an extension bar 29A in order to protrude the second lens barrel 32 sufficiently downward relative to the first lens barrel 42. A local area camera 30 is provided at the end (lower end) of the extension bar 29A.

Referring to FIG. 1, the computer device 10 is connected to a robot arm 20, a local area camera 30, a small ring light 34, a wide area camera 40, and a large ring light 44. The computer device 10 controls these devices. The computer device 10 is connected to the display device 16 and the input device 17. Referring to FIG. 1, the display device 16 is, for example, a display device. The input device 17 is, for example, a keyboard or a mouse.

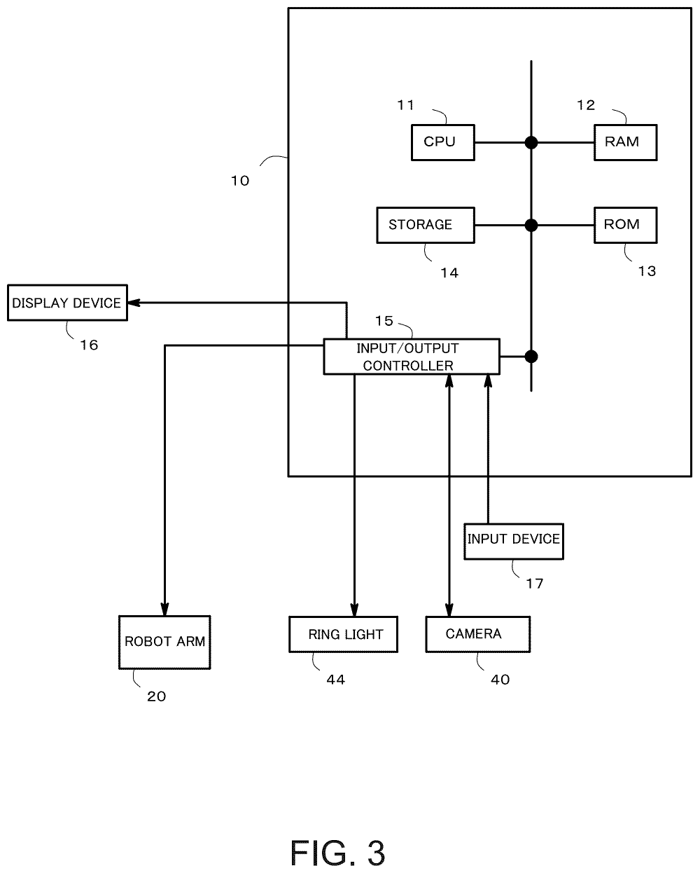

Referring to FIG. 3, the computer device 10 includes a CPU 11, a RAM 12, a ROM 13, a storage 14, and an input/output controller 15.

The CPU 11 is a central processing unit and is also called a processor. The RAM 12 is a volatile storage device that temporarily stores data during work. The ROM 13 is a storage device capable of reading data. The storage 14 is a storage device capable of writing and reading data. The storage 14 includes, for example, a hard disk drive (HDD) and a solid state drive (SSD).

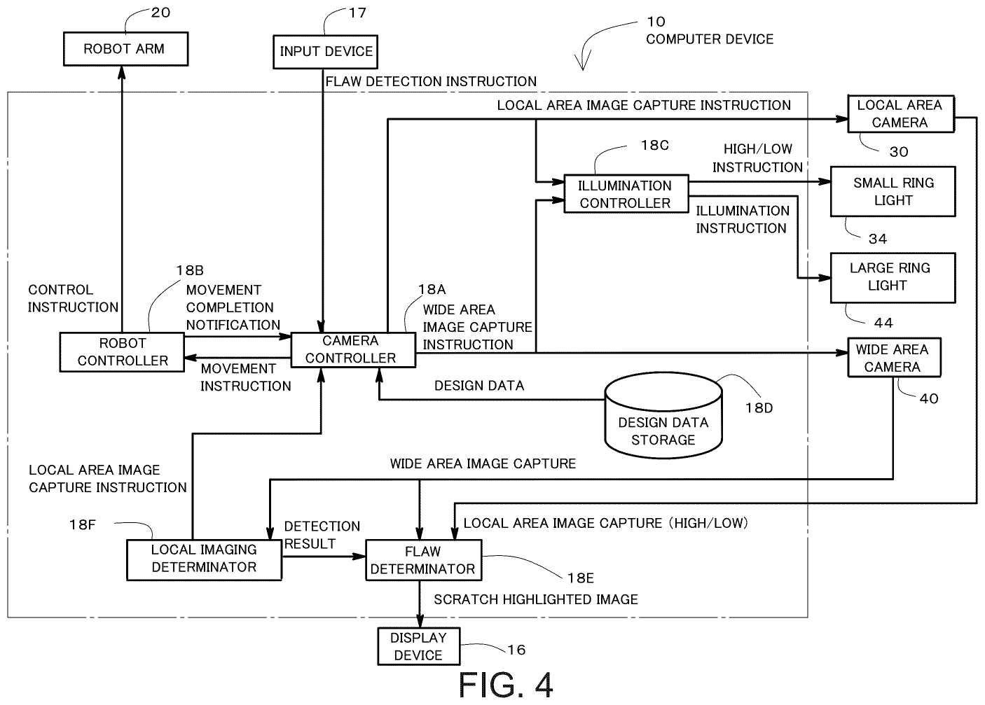

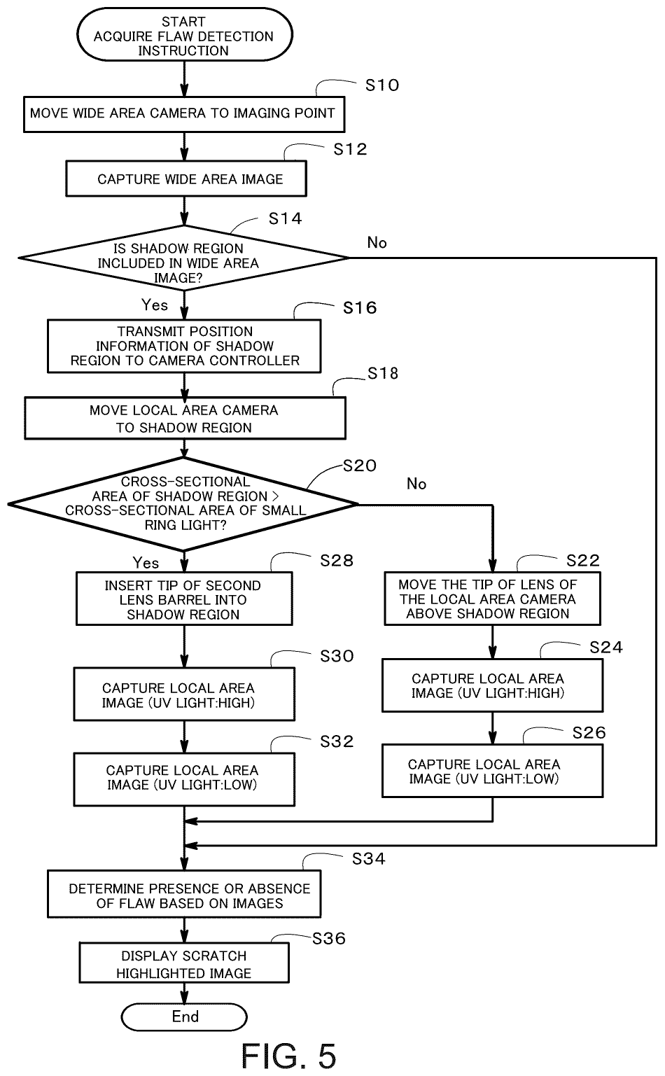

When the CPU 11 executes a program stored in the storage 14 or the ROM 13, a functional block illustrated in FIG. 4 is constructed in the computer device 10. The CPU 11 (processor) includes a camera controller 18A, a robot controller 18B, an illumination controller 18C, a flaw determinator 18E, and a local imaging determinator 18F. These functional blocks execute the flaw detection flow illustrated in FIG. 5.

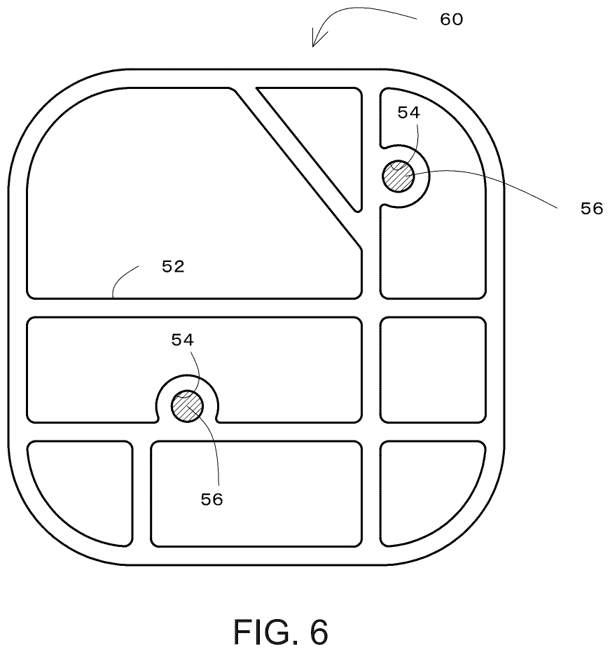

At least a part of the storage area of the ROM 13 or the storage 14 is allocated to the design data storage 18D. The design data storage 18D stores design data 60 of the test surface 51 to be inspected as illustrated in FIG. 6. In the design data 60, a shadow region 56 is set in advance. For example, the inside of the hole 54 is set as the shadow region 56. For example, the operator or the like sets the shadow region 56 using the input device 17 (see FIG. 1).

### 3. Flaw Detection Flow

Referring to FIG. 1, a test object 50 is disposed at a fixed position for a flaw detection test. For example, a stage (not shown) is provided in front of the robot arm 20. The test object 50 is placed on the stage. In the flaw detection inspection, the test surface 51 of the test object 50 is directed upward.

Further, the penetrant is applied to the test surface 51 by an operator or a coating robot. After the penetrant is applied, the penetrant on the test surface 51 is removed after a predetermined time. When the penetrant is removed, an instruction to start the flaw detection inspection is transmitted from the input device 17 (see FIG. 4) to the camera controller 18A. This instruction triggers the flaw detection flow of FIG. 5.

Referring to FIGS. 1, 4, and 5, the camera controller 18A transmits a movement command for capturing a wide area image to the robot controller 18B. In order to move the wide area camera 40 to a predetermined imaging point, the robot controller 18B controls the robot arm 20 (S10). For example, the robot controller 18B causes the center of the test surface 51 to coincide with the optical axis of the wide area camera 40. Further, the robot controller 18B separates the wide area camera 40 from the surface to be test surface 51. At the imaging point of the wide-area image, the entire surface of the test surface 51 is included in the field of view of the wide area camera 40.

When the wide area camera 40 is disposed at the imaging point, the robot controller 18B transmits a movement completion notification to the camera controller 18A. Upon receiving the movement completion notification, the camera controller 18A transmits an instruction to capture a wide area image (wide area imaging instruction) to the wide area camera 40 and the illumination controller 18C.

The illumination controller 18C sets the intensity of the large ring light 44 when capturing a wide area image. For example, when a wide-area image is captured, the intensity of ultraviolet rays is set to be high.

While the large ring light 44 is emitting light, the wide area camera 40 captures an image of the test surface 51 to be inspected (S12). FIG. 7 illustrates a wide area image 65 captured by the wide area camera 40. As the rib 52 becomes longer, the hole 54 becomes deeper, and as a result, the inside of the hole 54 becomes a shadow region 56.

The data of the wide area image is transmitted to the flaw determinator 18E and the local imaging determinator 18F. The local imaging determinator 18F determines whether a shadow region is included in the wide area image (S14). For example, the local imaging determinator 18F determines whether a shadow region is included in the wide area image based on the design data 60 (see FIG. 6). The design data 60 is stored in the design data storage 18D. The local imaging determinator 18F determines whether or not the shadow region 56 is set in the design data 60.

When the shadow region 56 is not set, the flaw detection step proceeds to step S32. For example, the local imaging determinator 18F transmits a determination result indicating that the shadow region 56 is not included in the wide area image to the flaw determinator 18E.

In step S14, when the shadow region 56 is set in the design data 60, the local imaging determinator 18F transmits an instruction to the camera controller 18A to capture a local image to the camera controller 18A. The local imaging determinator 18F extracts the shadow region 56 at the time of imaging by the wide area camera 40 based on the design data 60. For example, the local imaging determinator 18F transmits coordinate information (position information) of the shadow region 56 in the design data 60 to the camera controller 18A (S16).

The camera controller 18A includes the shadow region 56 in the imaging region by the local area camera 30. The camera controller 18A transmits a command to move the local area camera 30 to the robot controller 18B. In response to this, the robot controller 18B controls the robot arm 20 to move the local area camera 30 directly above the shadow region 56 (S18). That is, the shadow region 56 is included in the imaging region of the local area camera 30.

Next, the robot controller 18B determines whether or not the cross-sectional area of an opening to the shadow region 56 exceeds the cross-sectional area of the small ring light 34 (ultraviolet light headlamp) (S20). For example, the design data storage 18D stores the area in addition to the position of the shadow region 56. The robot controller 18B refers to the area information to compare the size relationship with the small ring light 34.

When the cross-sectional area of the shadow region 56 is equal to or smaller than the cross-sectional area of the small ring light 34, the small ring light 34 cannot be inserted into the shadow region 56. The robot controller 18B moves the objective lens 36 (see FIG. 2) of the local area camera 30 directly above the shadow region 56 (S22). Next, the camera controller 18A transmits a local imaging command to the local area camera 30 and the illumination controller 18C. Hereinafter, the image captured by the local area camera 30 is appropriately referred to as a “local image”.

The camera controller 18A transmits a local imaging command to the local area camera 30 and the illumination controller 18C. The local area camera 30 images the shadow region 56 (hole 54) a plurality of times from above. For example, a local image is captured twice. The illumination controller 18C makes the intensity of the ultraviolet light different in each imaging cycle.

For example, the wavelength band UV-A of ultraviolet rays irradiated by the small ring light 34 is 315 nm to 400 nm. On the other hand, it is known that the lower limit of the wavelength of visible light is 360 nm. That is, the light emitted from the small ring light 34 includes a visible light wavelength band component. In addition, the UV-LED, which is the light source of the small ring light 34, has strong linearity. Therefore, when the shadow region 56 is irradiated with the intensity High, the bottom surface 54A (see FIG. 8) of the shadow region 56 causes halation due to the visible light component. On the other hand, the inner peripheral surface 54B of the shadow region 56 (hole 54) is illuminated by the reflected light from the bottom surface 54A. That is, in the first imaging, an image of the inner peripheral surface 54B of the shadow region 56 is acquired.

The illumination controller 18C sets the intensity of the small ring light 34 when capturing the local image. For example, when a local image is captured, the intensity of ultraviolet rays is set to be high. While the small ring light 34 is emitting light, the local area camera 30 captures an image of a region including the inner peripheral surface 54B of the shadow region 56 (S24).

Next, the illumination controller 18C sets the intensity of the small ring light 34 to weak (Low). While the small ring light 34 is emitting light, the local area camera 30 captures a local image (S26). By this imaging, an image of the bottom surface 54A of the shadow region 56 (hole 54) is obtained. The two local images having different ultraviolet intensity are transmitted to the flaw determinator 18E.

In step S20, when the cross-sectional area of the shadow region 56 exceeds the cross-sectional area of the small ring light 34 (ultraviolet light headlamp), the robot controller 18B inserts the tip of the second lens barrel 32 of the local area camera 30 and the small ring light 34 into the shadow region 56 via the robot arm 20 (S28). For example, as illustrated in FIG. 8, the tip of the second lens barrel 32 and the small ring light 34 are inserted into the hole 54.

Next, the camera controller 18A transmits a local imaging command to the local area camera 30 and the illumination controller 18C. In a state where the tip of the second lens barrel 32 and the small ring light 34 are inserted into the hole 54, the local area camera 30 images the inside of the shadow region 56 (the hole 54) a plurality of times. For example, a local image is captured twice. The illumination controller 18C makes the intensity of the ultraviolet light different in each imaging cycle.

The illumination controller 18C sets the intensity of the small ring light 34 to be high when the first local image is captured. While the small ring light 34 is emitting light, the local area camera 30 captures a local image (S30). By this imaging, an image of the inner peripheral surface 54B of the shadow region 56 (hole 54) is obtained.

Next, the illumination controller 18C sets the intensity of the small ring light 34 to weak (Low). While the small ring light 34 is emitting light, the local area camera 30 captures a local image (S32). By this imaging, an image of the bottom surface 54A of the shadow region 56 (hole 54) is obtained.

The two local images having different ultraviolet intensity are transmitted to the flaw determinator 18E. When a plurality of shadow regions 56 are set on the test surface 51, the processing from step S16 to step S32 is repeated.

The flaw determinator 18E determines the presence or absence of a flaw on the test surface 51 from the wide area image captured in step S12 and the local image captured in steps S24 and S26 or steps S30 and S32 (S34).

Further, the flaw determinator 18E performs image processing for emphasizing the detected flaw on the wide area image and the local image. For example, the luminance of the damaged portion is increased as compared with that of the peripheral region. Further, the image after the scratch highlighting process (scratch enhanced image) is displayed on the display device 16 (S36).

### 4. Another Example of a Flaw Detection Flow

In the flaw detection flow of FIG. 5, in step S14, the shadow region 56 is determined from the design data 60. On the other hand, the shadow region 56 may be extracted from the wide area image 65 (see FIG. 7). According to this example, a region in which ultraviolet rays are actually blocked is extracted as the shadow region 56. As a result, imaging error can be reliably suppressed over the test surface 51.

In step S20 of FIG. 5, the area of the shadow region is used. The local imaging determinator 18F calculates the area of the shadow region 56 from the area of the shadow region 56 in the wide area image, the magnification of the wide area camera 40, the separation distance between the test surface 51 and the wide area camera 40, and the like.

In the flaw detection flow illustrated in FIG. 5, the intensity of the small ring light 34 was switched between high and low, and the shadow region 56 was imaged twice. Alternatively, the number of times of imaging may be one. In this case, a fluorescence bandpass filter (not shown) is attached to the local area camera 30.

The bandpass filter for fluorescence has high transmittance in the fluorescence wavelength band. In addition, the bandpass filter for fluorescence has high blocking performance in a wavelength band other than the fluorescence wavelength band. Therefore, for example, by mounting the bandpass filter in front of the objective lens, occurrence of halation in the captured image can be suppressed.

The present disclosure is not limited to the present embodiments described above, and includes all changes and modifications without departing from the technical scope or the essence of the present disclosure defined by the claims.

1. A fluorescent penetrant inspection apparatus comprising:
a wide area camera that captures an image of an object to be inspected; and
a local area camera that captures an image of a part of the object in a region captured by the wide area camera;
wherein the wide area camera includes a first lens barrel configured to support an objective lens;
the local area camera includes a second lens barrel and an ultraviolet flaw detection lamp having a ring shape;
the second lens barrel supports an objective lens;
the ultraviolet flaw detection lamp is disposed around the second lens barrel;
the diameter of the ultraviolet flaw detection lamp is less than the diameter of the first lens barrel; and
the second lens barrel has a barrel length longer than the first lens barrel.

2. The fluorescent penetrant inspection apparatus according to claim 1, further comprising:
a robot arm moving the local area camera relative to the object to be inspected; and
a processor configured to control the robot arm;
wherein the processor extracts a shadow region at the time of capturing the image by the wide area camera based on design data of the object to be inspected; and
the processor includes the shadow region in a region to be captured by the local area camera.

3. The fluorescent penetrant inspection apparatus according to claim 1, further comprising:
a robot arm moving the local area camera relative to the object to be inspected; and
a processor configured to control the robot arm;
wherein the processor extracts a shadow region from an image captured by the wide area camera, and
the processor includes the shadow region in a region to be captured by the local area camera.

4. The fluorescent penetrant inspection apparatus according to claim 2, wherein
when the cross-sectional area of an opening to the shadow region exceeds the cross-sectional area of the ultraviolet flaw detection lamp, the processor inserts an end of the second lens barrel into the shadow region via the robot arm.

5. The fluorescent penetrant inspection apparatus according to claim 4, wherein
the local area camera captures an image inside of the shadow region a plurality of times with the end of the second lens barrel inserted into the shadow region; and
the ultraviolet flaw detection lamp changes an intensity of ultraviolet light in each image capturing.
